(19) United States
(12) Patent Application Publication
(10) Pub. No.: US 2016/0147931 A1
(43) Pub. Date: May 26, 2016

(54) PROGRAMMABLE CAD SYSTEM SUITED FOR PREVENTING INTERFERENCE BETWEEN COMPONENT AND CHASSIS, AND METHOD THEREOF

(71) Applicants: INVENTEC (PUDONG) TECHNOLOGY CORPORATION, Shanghai (CN); INVENTEC CORPORATION, Taipei City (TW)

(72) Inventors: CHUNG-SHENG NI, Taipei City (TW); Chih-Pin Wei, Taipei (TW); Chun-Ying Yang, Taipei City (TW)

(21) Appl. No.: 14/684,448

(22) Filed: Apr. 13, 2015

(30) Foreign Application Priority Data
Nov. 24, 2014 (CN) 201410680588.X

(51) Int. Cl. G06F 17/50

(52) U.S. Cl. CPC G06F 17/5081

(57) ABSTRACT

A programmable CAD system suited for preventing interference between components and a chassis, and a method thereof are provided. The method comprises the following steps of: automatically obtaining a protruding length of a pin tail of a component outwardly protruded from a circuit board, by a first arithmetic unit; obtaining a distance, between a chassis and a surface of the circuit board corresponding to a location where the component is disposed, from a component information unit, obtaining an interference value according to the protruding length and the distance, by a second arithmetic unit; and determining whether the interference value is greater than zero, by a determine unit. If the interference value is greater than zero, the component is determined to be interfering with the chassis; and if not, the component is determined not to be interfering with the chassis.

### FIELD OF THE INVENTION

The present invention relates to a system suited for preventing interference between a component and a chassis, and a method thereof, and more particularly to, a programmable CAD system for preventing interference between a component and a chassis, and a method thereof.

### BACKGROUND OF THE INVENTION

In the field of electronic products research, development, and design, the design of the electronic circuit and the structural shape is an important item. Recently, since the technology of processing integrated circuits and the complexity of electronic products are being improving and increased day by day, the design of the electronic circuit and the structural shape is achieved by computer-aided design (CAD) systems. For example, the design of the electronic circuit is achieved by electronic computer-aided design (ECAD) systems, and the design of the structural shape is achieved by mechanical computer-aided design (MCAD) systems.

In general, the ECAD systems comprise Protel, PowerPCB, ORCAD, and so on, which are used for defining the design with respect to the packaging of components and the junction of electric circuits in an electric circuit schematic diagram. The MCAD systems comprise AutoCAD, Pro/ENGINEER, SolidEdge, and so on, which are used for defining the design with respect to the position of chassis holes and the configuration of parts in a circuit board. Therefore, in the design process, an MCAD design team will define a size restriction condition of the electronic products, such as the height restriction of al the electronic components on the circuit board. Next, an ECAD design team will create a layout of the electronic components according to the size restriction conditions.

However, the conventional ECAD systems lack the information of the overall length of the pin tails of the electronic components, so that detecting whether the position of each electronic component excesses a height restriction provided by the MCAD design team or not must be performed manually, so as to determine whether the electronic component is interfering with a chassis. Such a detection method does not only consume much time but also introduces the risk of human miscalculation. Accordingly, it is necessary to provide a system and a method suitable for the system to solve the above technical problems.

### SUMMARY OF THE INVENTION

To resolve the above technical problems, an objective of the present invention is to provide a method for preventing interference between a component and a chassis, which can be convenient for the operator to efficiently prevent interference problems between the component and the chassis at a stage when a circuit layout is being schematically designed, and would not find the problem caused from a human miscalculation until producing process.

To achieve the above-mentioned inventive objective, the present invention provides a method for preventing interference between a component and a chassis suitable for a programmable CAD system, comprising steps of: automatically obtaining a protruding length of a pin tail of the component outwardly protruded from a circuit board, by a first arithmetic unit; obtaining a distance, between the chassis and a surface of the circuit board corresponding to a location where the component is disposed, from a component information unit; obtaining an interference value according to the protruding length and the distance, by a second arithmetic unit; and determining whether the interference value is greater than zero, by a determine unit, where if the interference value is greater than zero, the component is determined to be interfering with the chassis; and if not, the component is determined not to be interfering with the chassis.

In a preferable embodiment of the present invention, the method further comprises: before obtaining the protruding length of the pin tail of the component outwardly protruded from the circuit board, obtaining an overall thickness of the circuit board and an overall length of the pin tail of the component from the component information unit.

In a preferable embodiment of the present invention, the component is disposed on an upper surface of the circuit board, and the pin tail of the component protrudes from a bottom surface of the circuit board.

In a preferable embodiment of the present invention, an interference notification signal is outputted from the programmable CAD system when the component is determined to be interfering with the chassis.

Another object of the present invention is to provide a programmable CAD system for preventing interference between a component and a chassis, which can be convenient for the operator to efficiently prevent interference problems between the component and the chassis at a stage when a circuit layout is being schematically designed, and would not find the problem caused from a human miscalculation until producing process.

To achieve the above-mentioned inventive objective, the present invention provides a programmable CAD system for preventing interference between a component and a chassis, comprising: a first arithmetic unit used for automatically obtaining a protruding length of a pin tail of the component outwardly protruded from a circuit board; a decision unit used for obtaining a distance between the chassis and a surface of the circuit board corresponding to a location where the component is disposed, from a component information unit; a second arithmetic unit used for obtaining an interference value according to the protruding length obtained by the first arithmetic unit and the distance obtained by the decision unit; and a determine unit used for determining whether the interference value obtained by the second arithmetic unit is greater than zero, where if the interference value is greater than zero, the component is determined to be interfering with the chassis; and if not, the component is determined not to be interfering with the chassis.

In a preferable embodiment of the present invention, the component information unit stores information of a thickness of the circuit board and information of an overall length of the pin tail of the component, so that the first arithmetic unit obtains the thickness of the circuit board and the overall length of the pin tail of the component from the component information unit, so as to obtain the protruding length of the component.

In a preferable embodiment of the present invention, an interference notification signal is displayed by a display unit when the component is determined to be interfering with the chassis by the determine unit.

### BRIEF DESCRIPTION OF THE DRAWINGS

FIG. 1 depicts a flow chart of a method for preventing interference between a component and a chassis, suitable for a programmable CAD system, according to a first embodiment of the present invention; and

FIG. 2 depicts a block diagram of the programmable CAD system according to the first embodiment of the present invention.

### DETAILED DESCRIPTION OF THE INVENTION

These and other features, aspects, and advantages of the present invention will become better understood with regard to the following description, appended claims, and accompanying drawings.

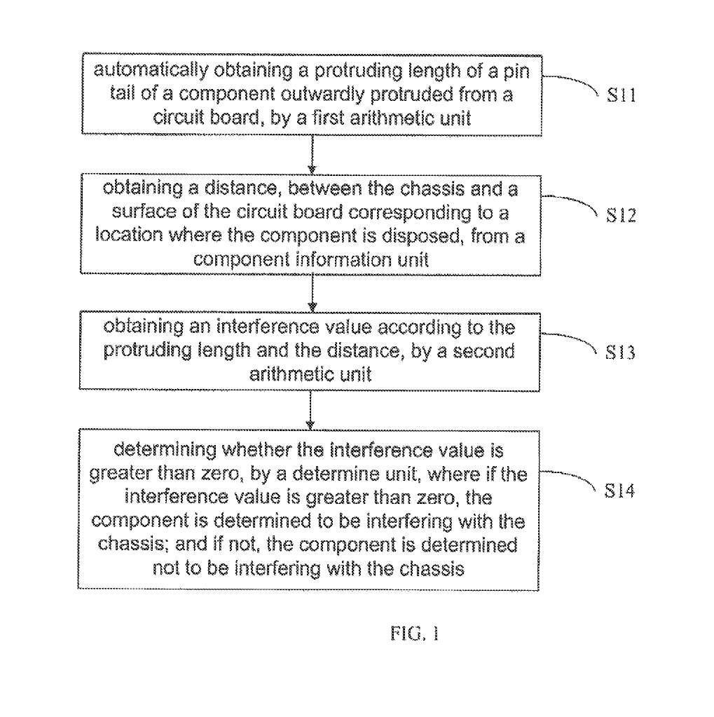

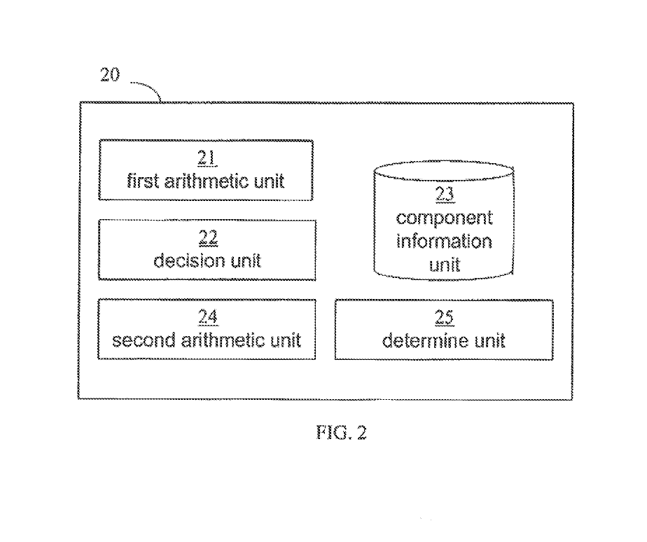

Please refer to FIG. 1 and FIG. 2. FIG. 1 depicts a flow chart of a method for preventing interference between a component and a chassis, suitable for a programmable CAD system, according to a first embodiment of the present invention, and FIG. 2 depicts a block diagram of the programmable CAD system 20 according to the first embodiment of the present invention. The programmable CAD system 20 comprises a program for designing circuit layout of a circuit board, which serves as the conventional ECAD system, and further comprises a first arithmetic unit 21, a decision unit 22, a component information unit 23, a second arithmetic unit 24, and a determine unit 25.

The circuit board designed by the programmable CAD system 20 comprises a plurality of components, which are disposed on an upper surface of the circuit board, and each of which has a pin tail protruded from a bottom surface of the circuit board. At the same time when designing the components on the circuit board by the programmable CAD system 20 of the present invention, the above-mentioned units 21 to 25 can be used to detect whether the plurality of components are interfering with the chassis after the pin tail of components protrude from the bottom surface of the circuit board.

Please refer to FIG. 1 and FIG. 2. The method for preventing interference between the components and the chassis by using the programmable CAD system 20 comprises the following steps firstly, in the step S11, a protruding length of the pin tail of the component outwardly protruded from the circuit board is automatically obtained by the first arithmetic unit 21. To be specific, the component information unit 23 stores the information which includes part numbers of various types of circuit boards, the corresponding thickness thereof, part numbers of various types of components, and the corresponding length thereof. When an operator selects a particular circuit board and a particular component to be to arranged, the thickness of the particular circuit board and the overall length of the pin tail of the particular component will be automatically obtained by the first arithmetic unit 21 from the component information unit 23, thereby automatically obtaining a value indicative of the protruding length of the pin tail of the particular component penetrated through and outwardly protruded from the surface of the is circuit board.

In general, the surface of the chassis of the electronic product may not be even. For example, in order to match with other parts in electronic products, the chassis is formed as a stepped shape, or the electronic product has a special appearance or design. That is, after assembling the circuit board with the chassis, different components on the circuit board will have different height restrictions. Therefore, after obtaining the protruding length of the component by the programmable CAD system 20, step S12 is performed. In the step S12, a distance between the chassis and the surface of the circuit board corresponding to a location where the component is disposed is obtained by the decision unit 22 of the programmable CAD system 20 from the component information unit 23.

Next, after the protruding length and the distance of the component are obtained by the programmable CAD system 20, step S13 is performed. In the step S13, an interference value is automatically obtained according to the protruding length and the distance by the second arithmetic unit 24. To be specific, the protruding length subtracts the distance of the component to obtain the interference value by using the second arithmetic unit 24.

After obtaining the interference value by the second arithmetic unit 24, the programmable CAD system 20 performs step S14. In the step S14, the determine unit 25 determines whether the interference value is greater than zero. If the interference value is greater than zero, then the component is determined to be interfering with the chassis. If not, then the component is determined not to be interfering with the chassis. Therefore, that the determine unit 25 can determine whether the pin tail of the component on the circuit board is contacted with the chassis.

In another embodiment of the present invention, when the component is determined to be interfering with the chassis by the determine unit 25, an interference notification signal can be transmitted to an operator by a display unit (not shown) of the programmable CAD system 20. In another embodiment, the interference notification signal can be presented in a variety of ways, such as by transmitting an alarm sound or displaying an error window, but it is not limited thereto.

Therefore, the programmable CAD system 20 provided by the present invention can execute a program for designing a circuit layout which serves as the conventional ECAD system. Also, by using the programmable CAD system 20, the present invention can be convenient for the operator to efficiently prevent interference problems between the component and the chassis at a stage when a to circuit layout is being schematically designed, and would not find the problem caused from a human miscalculation until producing process.

The above descriptions are merely preferable embodiments of the present invention, but are not intended to limit the scope of the present invention. Any modification or replacement made by those skilled in the art without departing is from the spirit and principle of the present invention should fall within the protection scope of the present invention. Therefore, the protection scope of the present invention is subject to the appended claims.

What is claimed is:

1. A method for preventing interference between a component and a chassis suitable for a programmable CAD system, comprising steps of:
automatically obtaining a protruding length of a pin tail of the component outwardly protruded from a circuit board, by a first arithmetic unit;
obtaining a distance, between the chassis and a surface of the circuit board corresponding to a location where the component is disposed, from a component information unit;
obtaining an interference value according to the protruding length and the distance, by a second arithmetic unit; and
determining whether the interference value is greater than zero, by a determine unit, wherein if the interference value is greater than zero, the component is determined to be interfering with the chassis; and if not, the component is determined not to be interfering with the chassis.

2. The method for preventing interference between the component and the chassis according to claim 1, further comprising: before obtaining the protruding length of the pin tail of the component outwardly protruded from the circuit board, obtaining a thickness of the circuit board and an overall length of the pin tail of the component from the component information unit.

3. The method for preventing interference between the component and the chassis according to claim 1, wherein the component is disposed on an upper surface of the circuit board, and the pin tail of the component protrudes from a bottom surface of the circuit board.

4. The method for preventing interference between the component and the chassis according to claim 1, wherein an interference notification signal is outputted from the programmable CAD system when the component is determined to be interfering with the chassis.

5. A programmable CAD system for preventing interference between a component and a chassis, comprising:
a first arithmetic unit used for automatically obtaining a protruding length of a pin tail of the component outwardly protruded from a circuit board;
a decision unit used for obtaining a distance, between the chassis and a surface of the circuit board corresponding to a location where the component is disposed, from a component information unit;
a second arithmetic unit used for obtaining an interference value according to the protruding length obtained by the first arithmetic unit and the distance obtained by the decision unit; and
a determine unit used for determining whether the interference value obtained by the second arithmetic unit is greater than zero, wherein if the interference value is greater than zero, the component is determined to be interfering with the chassis; and if not, the component is determined not to be interfering with the chassis.

6. The programmable CAD system according to claim 5, wherein the component information unit stores information of a thickness of the circuit board and information of an overall length of the pin tail of the component so that the first arithmetic unit obtains the thickness of the circuit board and the overall length of the pin tail of the component from the component information unit, so as to obtain the protruding length of the component.

7. The programmable CAD system according to claim 5, wherein an interference notification signal is displayed by a display unit when the component is determined to be interfering with the chassis by the determine unit.

8. A method for preventing interference between a component and a chassis suitable for a programmable CAD system, comprising steps of:
according to a thickness of a circuit board and an overall length of a pin tail of the component from a component information unit, automatically obtaining a protruding length of the pin tail of the component outwardly protruded from the is circuit board, by a first arithmetic unit;
obtaining a distance, between the chassis and a surface of the circuit board corresponding to a location where the component is disposed, from a component information unit;
obtaining an interference value according to the protruding length and the distance, by a second arithmetic unit; and
based on whether the interference value is greater than a preset value by a determine unit or not, determining whether the component is interfering with the chassis or not.

9. The method for preventing interference between the component and the chassis according to claim 8, wherein the component is disposed on an upper surface of the circuit board, and the pin tail of the component protrudes from a bottom surface of the circuit board.

10. The method for preventing interference between the component and the chassis according to claim 8, wherein the interference notification signal is presented by transmitting an alarm sound or displaying an error window.
